(19) United States
(12) Patent Application Publication
(10) Pub. No.: US 2008/0297590 A1
(43) Pub. Date: Dec. 4, 2008

(54) 3-D ROBOTIC VISION AND VISION CONTROL SYSTEM

(76) Inventors: Fred BARBER, Dearborn, MI (US); Dan Hess, Clinton Township, MI (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/756,130

(22) Filed: May 31, 2007

(51) Int. Cl. H04N 13/02

(52) U.S. Cl. 348/47; 348/E13.074; 901/47

(57) ABSTRACT

A robotic vision and vision control system includes a stereoscopic camera mounted on a robot and a remote three-dimensional display system that provides the operator of the robot with a good sense of depth or distance for more precisely maneuvering the robot. The stereoscopic display system can further include an eye-tracking system that monitors the operator's eyes to determine the direction in which the operator's eyes are looking and points the camera in that direction.

### CROSS-REFERENCE TO RELATED APPLICATIONS

The benefit of the filing date of U.S. Provisional Patent Application Ser. No. 60/721,511, filed Jun. 1, 2006, entitled 3-D ROBOTIC VISION AND VISION CONTROL SYSTEM, is hereby claimed, and the specification thereof incorporated herein in its entirety by this reference.

### BACKGROUND OF THE INVENTION

1. Field of the Invention

The present invention relates generally to robotics and electronic displays and, more specifically, to a 3-D robotic vision system and visual feedback control system to allow an operator to experience improved remote control of a robot.

2. Description of the Related Art

In many applications, a remote control robot is used to accomplish a task that is difficult or dangerous for a human to accomplish. A ready example of such is bomb investigation and disposal, such as performed by law enforcement. Another similar example of such is evaluating Improvised Explosive Devices (IEDs), such as often occurs in combat (especially asymmetric warfare).

Unfortunately, the remote control of a robot can be cumbersome, slow and clumsy. This is due in part to the fact that the human operator is accustomed to a true stereoscopic view of the world when looking at the world through his or her eyes. In using a remote camera on the robot, oftentimes the operator is presented with less than true stereoscopic views. Moreover, the operator is accustomed to interacting with physical objects in an intuitive, direct manner using the stereoscopic information provided by his or her eyes. The technology interface between the operator and the robot tends to make the operator's control of the robot somewhat less intuitive, clumsier, slower, and more indirect than the operator is normally accustomed to experience in interacting physically with objects.

Accordingly, it can be seen that a need remains in the art for an improved stereoscopic robotic vision system and robotic vision control system. It is to the provision of such that the present invention is primarily directed.

### SUMMARY OF THE INVENTION

The present invention relates to a system and method for remote robotic vision and vision control comprising a stereoscopic video camera mounted to a robot, and a remotely located stereoscopic display system. The stereoscopic imagery captured by the stereoscopic camera is transmitted via a wired or, alternatively, wireless communication link, to the stereoscopic display system, thereby allowing the operator of the robot to perceive depth and distance to objects in a manner that allows the operator to more precisely maneuver or otherwise use the robot.

The stereoscopic display system can further include an eye-tracking system that monitors the operator's eyes to determine the direction in which the operator's eyes are looking and points the camera in that direction.

### BRIEF DESCRIPTION OF THE DRAWINGS

FIG. 1 illustrates a remotely controlled robot having a stereoscopic camera mounted thereon.

FIG. 2 is a block diagram of a stereoscopic robotic vision and vision control system that includes the robot and camera of FIG. 1.

FIG. 3 is a flow diagram illustrating a method for providing stereoscopic robotic vision and vision control.

### DETAILED DESCRIPTION

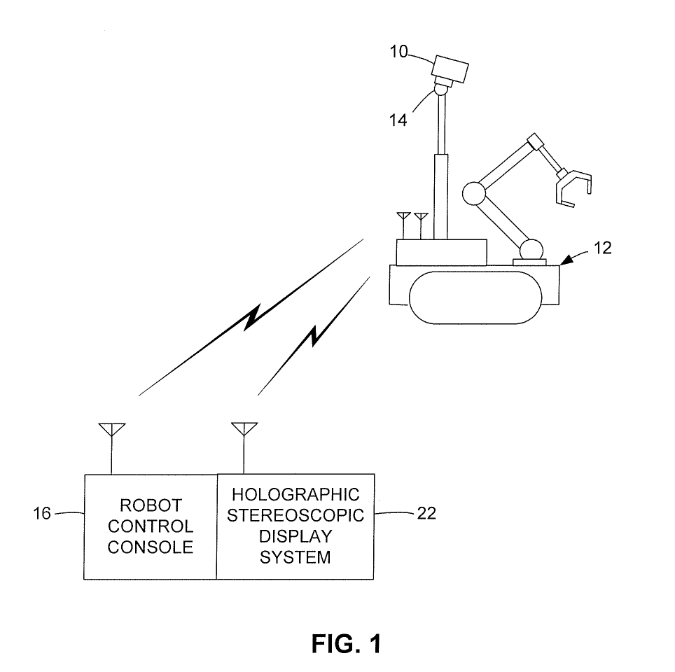

As illustrated in FIG. 1, in an exemplary embodiment of the present invention, a stereoscopic camera system 10 is mounted to a remotely controllable robot 12. Camera system 10 includes a mount 14 with servomotors or similar electronically controllable actuators that can point (e.g., pan and tilt) the stereoscopic cameras in various directions. Like robot 12, camera system 10 and its camera mount 14 are remotely controllable by an operator from an operator console 16. The communication link between robot 12 and console 16 can use a tethered (e.g., copper wire or optical fiber) or, alternatively, a wireless (i.e., radio) connection, as well known in the art.

Robot 12 can be of any suitable type, such as those commonly used by bomb disposal teams and hazardous materials handlers. The REMOTEC ANDROS F6A, available from Remotec of Clinton, Tenn., is an example of a suitable robot and includes an extendable arm on which camera system 10 can be mounted, a powered manipulator arm with multiple degrees of freedom, and a tracked locomotion system. However, in other embodiments the robot can be of a type used for any other suitable purpose, such as a miniature robot used for performing micro-surgery. As described in further detail below, the stereoscopic nature of camera system 10 provides the operator with a sense of depth (i.e., depth perception) that allows the operator to more precisely navigate the robot and manipulate objects than with conventional non-stereoscopic vision systems.

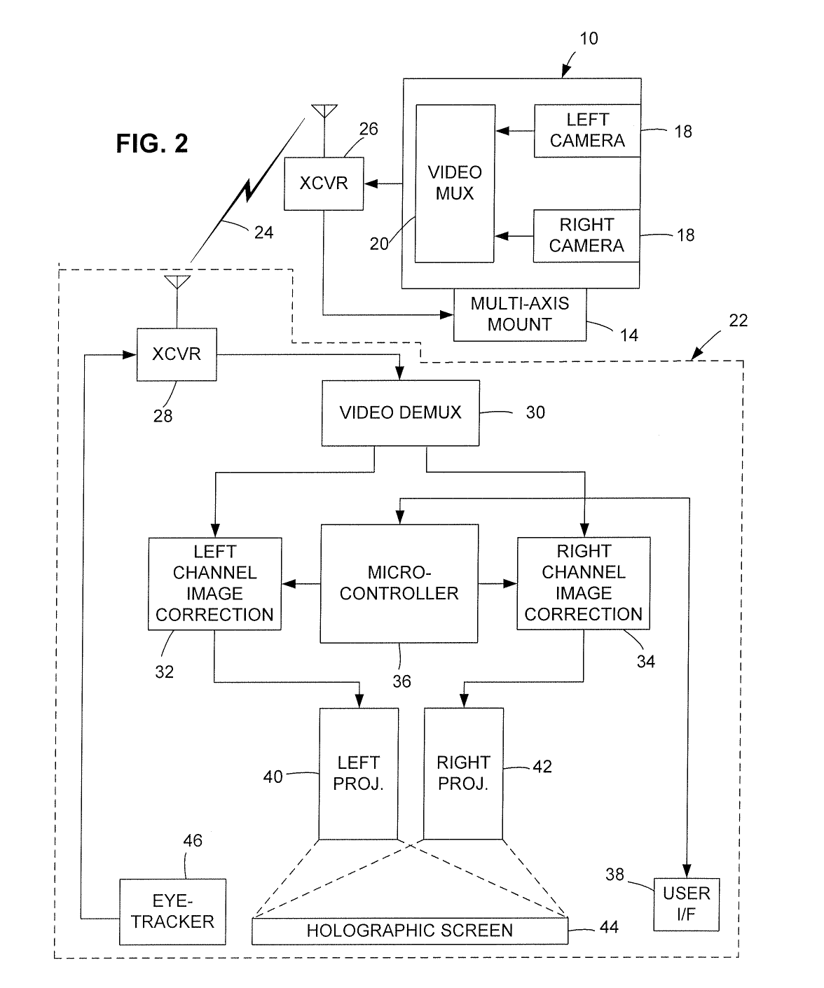

As further illustrated in FIG. 2, camera system 10 includes two video cameras 18, spaced at approximately the distance at which human eyes are spaced, so as to produce stereoscopic video imagery. A video multiplexer 20 multiplexes the signals representing the imagery produced by the “left-eye” camera 18 and “right-eye” camera 18 so that they can readily be transmitted to a display system 22 via a communication link 24. An example of a suitable camera system is the STERE-OPSIS, available from Bristlecone Corporation of New York, N.Y., which includes a “weatherproof, blast-resistant” enclosure in which cameras 18 are mounted. Robot 12, its operator console 16, and the communication link between them are not shown in FIG. 2 for purposes of clarity. However, display system 22 is co-located with operator console 16 so that the robot operator can view the received imagery.

A suitable radio transceiver 26 in robot 12 communicates information with a corresponding transceiver 28 in display system 22. In the exemplary embodiment, this information includes imagery produced by cameras 18 as well as signals for controlling camera mount 14. In other embodiments, signals for controlling camera mount 14 can be transmitted through additional transceivers (not shown) to define a separate communication link.

Display system 22 further comprises a video multiplexer 30 that receives the video signals and separates them into a left channel (corresponding to the “left-eye” camera 18) and a right channel (corresponding to the “right-eye” camera 18). Left-channel image correction circuitry 32 and right-channel image correction circuitry 34 receive the corresponding signals and perform any image processing that may be necessary or desirable in order to produce a holographic output, as described below. A microcontroller 36 controls left and right channel image correction circuitry 32 and 34. User interface elements 38, such as controls through which the operator can adjust the image, are coupled to microcontroller 36. A left-channel projector 40 and a right-channel projector 42, along with a holographic screen element 44, define a holographic display. An example of a suitable holographic display is that which is available from 3D Advanced Technologies of Detroit, Mich. This display is referred to as auto-stereoscopic because it does not require the use of polarized eyewear or other external viewing aids for a user to view a stereoscopic image. Rather, it creates the stereoscopic image using holography, by projecting left and right images onto holographic screen element 44.

In the exemplary embodiment of the invention, display system 22 further includes an eye-tracking subsystem that comprises an eye-tracker 46 mounted on or near screen element 44 that monitors the operator's eyes to determine the direction in which the operator is looking and provides a feedback signal for controlling the position of camera mount 14. That is, the signal from eye-tracker 46 is transmitted via communication link 24 to robot 12, where the signal is input to camera mount 14. Camera mount 14 responds to this signal by pointing cameras 18 in a direction with respect to the field of view of robot 12 corresponding to the direction in which the operator of robot 12 is looking with respect to the holographic display. A suitable eye tracking subsystem is the EYEGAZE, available from LC Technologies, Inc. of McLean, Va. The depth perception afforded by this system allows the operator to view the area in which robot 12 is operating with greater clarity and to more precisely control robot 12. The depth perception is especially helpful to an operator attempting to cause the manipulator arm to grasp or touch an object.

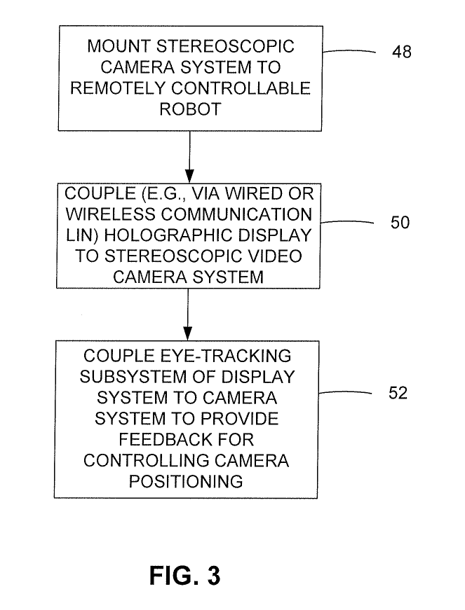

A method for providing robotic vision and vision control in accordance with the present invention is shown in the flow diagram of FIG. 3. At step 48, stereoscopic camera system 10 is mounted to remotely controllable robot 12. At step 50, stereoscopic camera system 10 is coupled to stereoscopic display system 22 via a wired or, alternatively, wireless data communication link. As described above, the stereoscopic display system can be auto-stereoscopic or holographic, freeing the operator from having to use polarized eyewear or other external viewing aids. This step provides the operator of the robot with a stereoscopic view of what the operator is doing with the robot. Additionally, as indicated by step 52, camera system 10 can be coupled to an eye-tracking system so that feedback, indicating the direction in which the operator is looking, can be used to control pointing of camera system 10.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A robotic vision and vision control system for remote robot control, the system comprising:
a stereoscopic video camera system mounted to a remotely controllable robot; and
a stereoscopic display system remotely coupled to the stereoscopic video camera system for viewing by an operator remotely controlling the robot.

2. The system claimed in claim 1, wherein the stereoscopic display system is a holographic display system.

3. The system claimed in claim 2, wherein the holographic display system comprises a holographic screen and dual projectors for projecting left-eye and right-eye images upon the holographic screen.

4. The system claimed in claim 1, wherein the stereoscopic display system further comprises an eye-tracking subsystem for tracking a direction of an operator's eyes and providing a feedback signal to the stereoscopic video camera system for controlling pointing of the stereoscopic video camera system.

5. The system claimed in claim 4, wherein the stereoscopic display system is a holographic display system.

6. The system claimed in claim 5, wherein the holographic display system comprises a holographic screen and dual projectors for projecting left-eye and right-eye images upon the holographic screen.

7. A method for providing robotic vision and vision control, comprising:
mounting a stereoscopic video camera system to a remotely controllable robot; and
coupling a stereoscopic display system to the stereoscopic video camera system, the stereoscopic display system co-located with a robot operator console for viewing by an operator remotely controlling the robot.

8. The method claimed in claim 7, wherein the step of coupling a stereoscopic display system to the stereoscopic video camera system comprises coupling a holographic display system to the stereoscopic video camera system.

9. The method claimed in claim 8, wherein the step of coupling a holographic display system to the stereoscopic video camera system comprises coupling a holographic display system comprising a holographic screen and dual projectors for projecting left-eye and right-eye images upon the holographic screen.

10. The method claimed in claim 7, wherein the step of coupling a stereoscopic display system to the stereoscopic video camera system further comprises coupling an eye-tracking subsystem for tracking a direction of the operator's eyes and providing a feedback signal to the stereoscopic video camera system for controlling pointing of the stereoscopic video camera system.

11. The method claimed in claim 10, wherein the step of coupling a stereoscopic display system to the stereoscopic video camera system comprises coupling a holographic display system to the stereoscopic video camera system.

12. The method claimed in claim 11, wherein the step of coupling a holographic display system to the stereoscopic video camera system comprises coupling a holographic display system comprising a holographic screen and dual projectors for projecting left-eye and right-eye images upon the holographic screen.
